(19) United States
(12) Patent Application Publication
(10) Pub. No.: US 2012/0100237 A1
(43) Pub. Date: Apr. 26, 2012

(54) QUICK-CHANGE SYSTEM FOR STRETCHING RODS

(76) Inventors: Kevin Folger, Alteglofsheim (DE); Philipp Albers, Detmoldt (DE); Thomas Hoellriegl, Teublitz (DE); Frank Winzinger, Regensburg (DE)

(21) Appl. No.: 13/122,303

(22) PCT Filed: Sep. 18, 2009
(86) PCT No.: PCT/EP09/62108

§ 371 Date: Jun. 13, 2011

(30) Foreign Application Priority Data
Oct. 2, 2008 (DE) 10-2008-049.905.6

(51) Int. Cl. B29C 49/12

(52) U.S. Cl. 425/3; 425/183

(57) ABSTRACT

A device for shaping plastic preforms into plastic containers may include a blowing nozzle for filling the plastic preform with a medium, and a rod body for extending the plastic preform in the longitudinal direction thereof during the shaping process. The rod body may be disposed on a support and may be movable in a longitudinal direction of the plastic preform. The rod body has a multi-part construction and includes at least one first rod element arranged on the support and one second rod element, which can be connected to the first rod element. The second rod element can be inserted into an opening of the plastic preform in order to extend the plastic preform in the longitudinal direction thereof, and the second rod element includes a contact surface in order to contact an area of the plastic preform. The first rod element and the second rod element can be connected to each other through a connection mechanism which can be released without tools.

The present invention relates to stretching blow moulding machines.

Machines of this type are used in the prior art in order for example to produce beverage containers from plastics material pre-forms. In this case the plastics material pre-forms are acted upon with a gaseous medium, such as for example air, and are expanded in this way. In order to assist this expansion process, use is made in part of so-called stretching rods which assist this expansion process by extending the pre-forms in the longitudinal direction thereof. In this case the use of different stretching rods is required by different containers or pre-forms, in particular depending upon the geometrical dimensions thereof.

U.S. Pat. No. 3,513,502 describes a quick change holder for a blow moulding needle. In this case an element is provided which supports this blow moulding needle as well as a further element which is arranged on a blow moulding body, it being possible for these two elements to be separated from each other.

GB 1 487 708 describes a blow moulding needle arrangement. In this case a hollow tube is fastened to a piston, in which case a blow moulding needle can be removed from a piston device without the piston rod being removed from the latter.

EP 1 694 492 B1 describes an arrangement for the releasable fastening of a stretching rod to a slide. In this case the entire stretching rod is arranged on the slide in question. In order to insert or replace a stretching rod, it can be turned with respect to a support or slide and it can then be removed from these supports by a bayonet-like closure. In this case, however, on account of the frequently difficult accessibility of this support it is difficult to some degree to remove the stretching rod from the support.

The object of the present invention is to provide a stretching blow moulding machine which permits a rapid and simple adaptation of a stretching rod to different circumstances and, in particular, to different pre-forms. This is attained according to the invention by an apparatus in accordance with claim 1 and by a stretching rod in accordance with claim 13. Advantageous embodiments and further developments form the subject matter of the sub-claims.

An apparatus according to the invention for shaping plastics material pre-forms to form plastics material containers has a blowing nozzle in order to fill the plastics material pre-form with a medium so as to expand it in this way. In addition, the apparatus has a rod member which is arranged on a holding means and which is movable in a longitudinal direction of the plastics material pre-form in order to extend the plastics material pre-form in the longitudinal direction thereof during the shaping procedure.

According to the invention the rod member is designed in a multiplicity of parts and preferably in two parts and has at least one first rod element arranged on the holding means as well as a second rod element capable of being connected to the first rod element, the second rod element being capable of being inserted into an opening of the pre-form in order to extend the latter in the longitudinal direction thereof, and the second rod element has a contact face in order to contact an area of the plastics material pre-form, in which case the first rod element and the second rod element are capable of being connected to each other by way of a connecting mechanism capable of being released without any tools.

In contrast to apparatus known from the prior art it is proposed in this case that the device should be designed in such a way that it is possible for the second rod element to be released without the use of a tool and, in particular, of screwdrivers and the like. In this way, the apparatus can be rapidly adapted to different circumstances of the pre-forms. Expressed in more precise terms, second rod elements which constitute the actual active elements for the stretching procedure can be rapidly exchanged in each case without the use of a tool and, in particular, by hand. In the prior art this represents a very complicated procedure since access to the release mechanisms for the stretching rods is frequently very difficult. In this way, it is preferable for neither of the two rod elements to extend along the entire longitudinal extension of the stretching rod or the rod member. The interior of the rod member can have a flow duct for a medium, in particular a gaseous medium, so that it is possible for the rod member also to be used as a rinsing rod. In addition, it would be possible for at least the second rod element to have ducts which extend in the radial direction and through which a gaseous medium can pass.

It would also be possible, however, for the rod member according to the invention to be designed in such a way that the second rod element is capable of being removed from the first rod element whilst using a tool, such as for example an open-ended spanner. The Applicants reserve the right also to claim protection for an arrangement of this type. In this way, it would be possible for the tool to be used solely for loosening the connecting mechanism and for the complete separation then to be carried out by hand. In this case the two-part design of the rod member or the stretching rod in any case allows a simpler dismantling than if the entire element had to be detached from its holding means.

In the case of a preferred embodiment the second rod element has a receiving area into which a connecting portion of the first rod element is capable of being inserted. In this way, in the case of this embodiment the second rod element is pressed onto an area of the first rod element at least in part. In this case it is preferable for this receiving area to surround the connecting portion in the peripheral direction completely. The receiving area is thus designed in the manner of a blind hole, into which the connecting portion is capable of being inserted. The receiving area and the connecting portion together form the connecting mechanism mentioned above or a part thereof. In addition to this receiving area and the connecting portion, however, the connecting mechanism usually has other component parts, such as in particular engagement means, magnetic elements, screw fastenings capable of being released without any tools, or the like.

In the case of a preferred embodiment the second rod element is capable of being withdrawn from the first rod element. This means that in this case in particular no screw fastening is provided between the two rod elements. It is possible, however, for the second rod element first to be released from the first rod element by a slight rotation and then to be withdrawn in the longitudinal direction of the rod element.

It would also be possible, however, for a screw fastening which is capable of being released without any tools to be provided between the first rod element and the second rod element. In this way, for example, the outer surface of the second rod element could have a texturing so that this second rod element might be gripped more easily in order to unscrew it from the first rod element.

In the case of a further advantageous embodiment an engagement member capable of being moved radially with respect to the second rod element is arranged on the first rod element. This engagement member preferably acts in this case as a rotation-prevention means or as a loosening-prevention means, in order to prevent the second rod element from being inadvertently detached from the first rod element. In this case it is preferably necessary for the engagement member to be actuated in order to be able to detach the rod elements from each other. The engagement member is preferably also movable with respect to the first rod element. The movement of the engagement member with respect to the respective rod element can be both a purely radial movement and such a movement which, in addition to a radial component, also contains further components (for example in the longitudinal direction).

In the case of a further advantageous embodiment the engagement member has an engagement portion which engages in an area of the second rod element in an assembled state of the rod elements. This engagement portion is used to prevent rotation and in the case of a preferred embodiment it can be actuated manually both when unscrewing and when screwing in the second rod element. In particular, however, a manual actuation is advantageous when unscrewing, and in a further embodiment the engagement portion can also engage manually when being screwed in.

In the case of a further advantageous embodiment the first rod element has a recess in which at least one portion of the engagement member is arranged in an assembled state. Prevention of rotation is achieved by means of this engagement. In addition, during the movement of the engagement member it can pass through the recess (in particular in the peripheral direction of the rod member). It is preferable for the engagement member to be produced from a plastics material or even from a stainless steel.

In the case of a further advantageous embodiment a spring element is provided, preferably on the first rod element, which pre-stresses the engagement member with respect to the first rod element. On account of this spring element it is possible for a prevention of rotation between the two rod elements to occur in a state of rest.

In the case of a further advantageous embodiment the first rod element has a retention means which prevents the engagement member from falling out of the first rod element. The nature of this retention means is explained in greater detail with reference to the figures.

It is pointed out that the respective arrangement of the engagement member described can also be carried out in a different way. In particular, it is possible for the engagement member to be arranged in a reverse manner on the second rod element and for a portion of this engagement member to engage in the first rod element. In a corresponding manner, the retention means could also be arranged on the second rod element and, in a reverse manner, the recess could be provided on the first rod element.

In the case of a further advantageous embodiment the engagement member is a spherical body which, in particular, can engage in a recess in the manner of a hole for example. In the case of a further advantageous embodiment a plurality of engagement members are distributed uniformly around the external periphery of the first rod element. In this case, however, it is possible for the engagement members to be arranged offset from one another in the longitudinal direction of the rod element.

It would also be possible, however, for all the engagement members to be arranged within a peripheral angle of less than 180°, so that they can be actuated more easily with one hand at the same time.

In the case of a further advantageous embodiment the engagement member is arranged so as to be pivotable about a pre-set pivot axis. In this case this pivot axis or a corresponding pivot shaft can be incorporated in a rod element and, in particular, in the first rod element.

In the case of a further advantageous embodiment an engagement member, which extends in the peripheral direction of the first rod element and the external cross-section of which is adapted to an internal cross-section of an engagement recess provided on the second rod element, is arranged on the first rod element. In this way, it is possible for example for the first rod element to have an element which is designed in a non-circular manner in a radial direction and which engages in a correspondingly designed recess in the second rod element. This arrangement is explained in greater detail with reference to the description of the figures.

In the case of a further preferred embodiment the first rod element and the second rod element are connected to each other by way of a connecting mechanism acting magnetically. In this way it would be possible, for example, for a magnet which co-operates with a magnetizable face of one of the rod elements to be arranged in the other rod element. In addition, magnets could be arranged in the two rod elements. In this case the aforesaid magnets or magnetizable elements are also component parts of the connecting mechanism.

It is preferable for the apparatus to be a stretching blow moulding machine, this machine advantageously having a furnace for heating the plastics material pre-forms and this furnace being arranged upstream in the conveying direction with respect to the shaping unit for shaping plastics material pre-forms to form plastics material containers.

In addition, the apparatus preferably has a turntable with a plurality of blow moulding stations in which the blow moulding process for forming a container by means of stretching with a stretching rod and stressing with pressure by the blowing nozzle is then carried out.

The present invention additionally relates to a rod member for an apparatus for shaping plastics material pre-forms to form plastics material containers. In this case this rod member is designed in a multiplicity of parts and has at least one first rod element capable of being arranged on a holding means as well as a second rod element capable of being connected to the first rod element, the second rod element being capable of being inserted into an opening of a pre-form in order to extend the latter in the longitudinal direction thereof, and the second rod element having a contact face in order to contact an area of the plastics material pre-form, in which case the first rod element and the second rod element are capable of being connected to each other and preferably also capable of being detached from each other by way of a connecting mechanism capable of being released without any tools. In particular, this is a multiple-part connecting mechanism.

Further advantages and embodiments are evident from the accompanying drawings. In the drawings

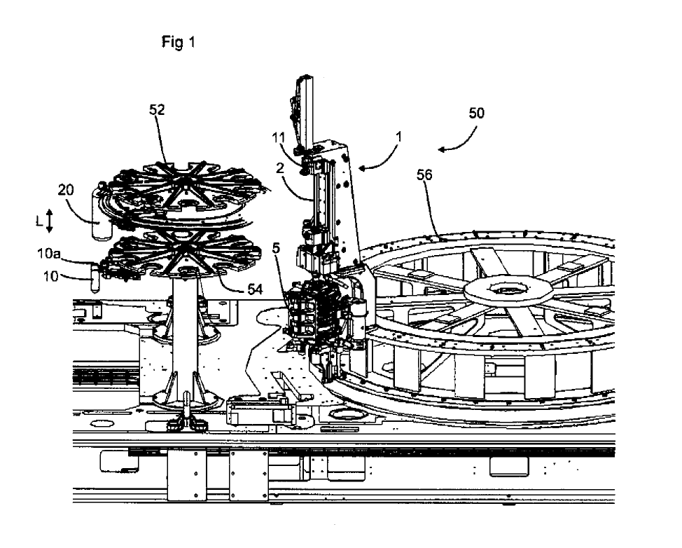

FIG. 1 is a view of a stretching blow moulding machine according to the prior art;

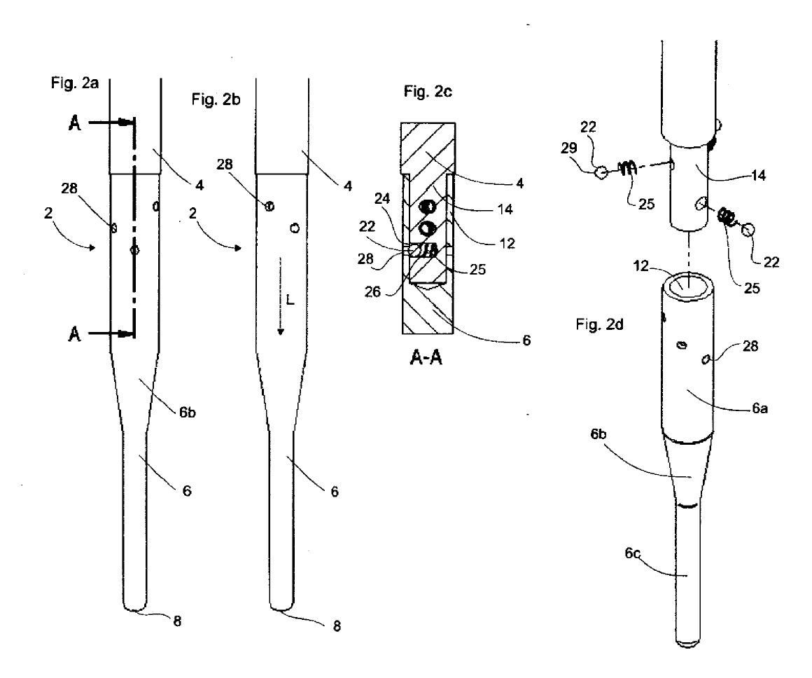

FIGS. 2a to 2d show a first embodiment of a rod member according to the invention;

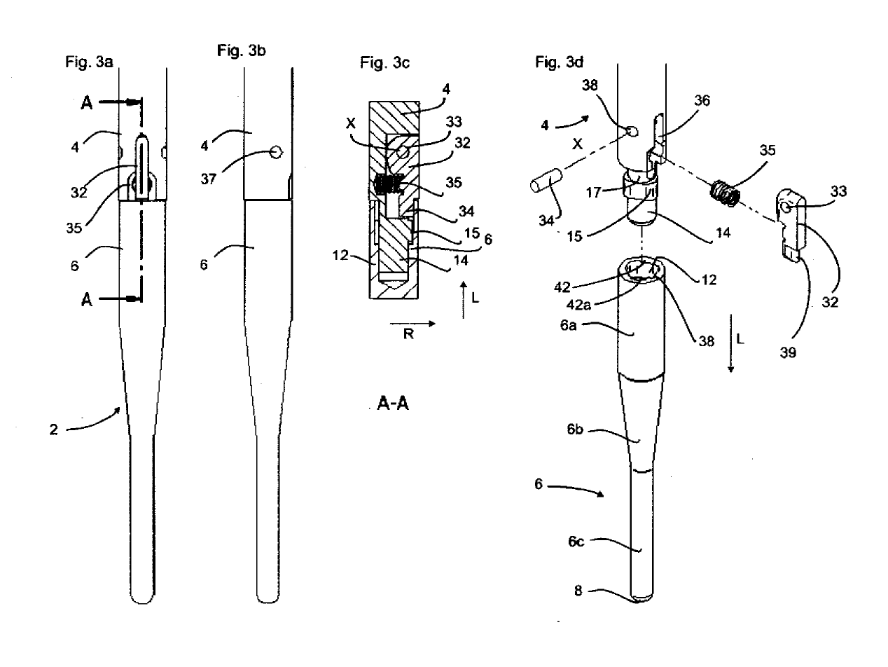

FIGS. 3a to 3d show a second embodiment of a rod member according to the invention;

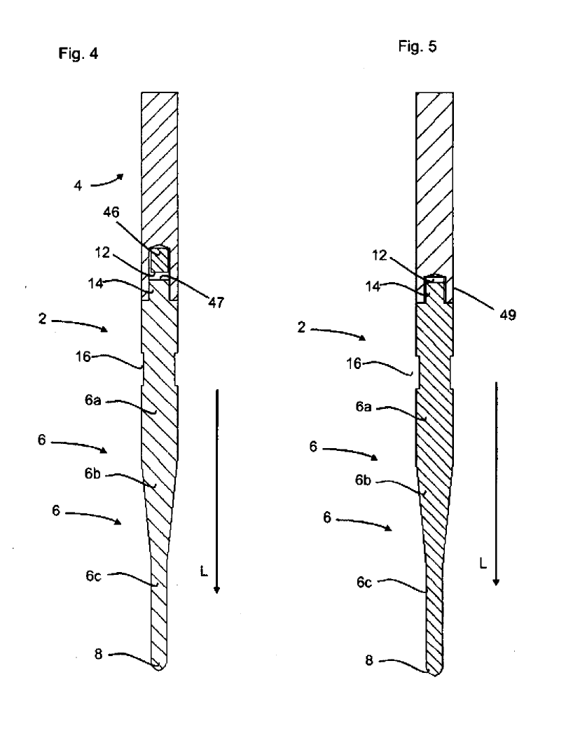

FIG. 4 shows a third embodiment of a rod member according to the invention, and

FIG. 5 shows a fourth embodiment of a rod member according to the invention.

FIG. 1 shows a machine 50 for the handling of containers. In this case the reference number 1 relates in its entirety to an apparatus for shaping pre-forms 10 to form containers 20. Expressed in more precise terms, the pre-forms 10 are supplied to this apparatus 1 by way of a first star wheel 54 and the pre-forms are then shaped in the apparatus 1 to form containers 20, in which case they are conveyed during this shaping procedure on a conveying wheel 56 acting as a conveying device. The containers produced in this way are then conveyed away by way of a further star wheel 52 (which is illustrated only in part). For the sake of simplicity only one apparatus 1 is illustrated.

In this case the apparatus 1 has a blow mould 5, inside which the actual shaping procedure takes place. In addition, the apparatus has a rod member or a stretching rod 2, the upper end of which is arranged on a holding means 11. During the expansion procedure the holding means 11 moves downwards with the stretching rod and in this way an extension procedure of the pre-forms 10 in the longitudinal direction L thereof takes place. At the same time, air is introduced into the pre-forms by way of a blowing nozzle in order to expand them. The reference 10a relates to an opening of the pre-form 10, by way of which the stretching rod 2 is inserted into the pre-form 10.

FIG. 2a is a first illustration of a rod member according to the invention designated 2 in its entirety. This rod member has in this case a first rod element 4 and a second rod element 6 capable of being separated from this rod element 4. The second rod element 6 has on the underside thereof a contact face 8 which during the shaping procedure contacts a base of a pre-form so as to extend it in this way. Holes or recesses 28, into which balls can engage in part from the inside in order to secure the second rod element 6 with respect to the first rod element 4, may be seen on the external periphery of the second rod element 6.

FIG. 2b is a further illustration in a different perspective of the rod element shown in FIG. 1a. It is evident that the individual holes 28 are arranged at different levels in the longitudinal direction L of the rod member 2.

FIG. 2c is a section along the lines A-A in FIG. 2a. It is evident that in the interior of the rod member 2 the first rod element 4 has a connecting portion 14 which engages in a receiving area 12 of the second rod element 6 and is completely surrounded in this case by this receiving area 12.

In this case, inside this connecting portion 14 three recesses 26 in the form of blind holes are provided, in which engagement members 22 in the form of balls are arranged in each case. The reference number 25 relates to a spring which pre-stresses the respective ball radially outwards, i.e. in the direction of the second rod element 6 or the receiving portion 12. In this case projections or edges 24 are provided which prevent the ball 22 from being able to fall out of the recess 26. In this way, these edges act as retention means. The connecting mechanism is formed on the one hand by the receiving area 12 and the connecting portion 14 and on the other hand by the engagement members 22 and the holes 28.

At the same time, however, a specific area 29 of this ball 22 projects in the radial direction beyond the external periphery of the connecting portion 14 and in this way it can engage from the inside in the opening 28 also shown in FIG. 1b. In this way, locking of the two rod elements 4 and 6 against each other can be achieved. In order to detach the second rod element 6 from the first rod element 4 it is possible first to turn it in order to move the three balls 22 out of engagement with the holes or openings 28, and then to withdraw it downwards away from the first rod element 4.

FIG. 2d is a further view of the rod member 2 shown in the preceding FIGS. 2a to 2c. In this case the holes 28 are again evident. The second rod element has an upper portion 6a which merges into a lower portion 6c by way of a transition portion 6b. This lower portion 6c is that region which dips into the interior of the pre-form for the expansion thereof.

FIGS. 3a to 3d show a further embodiment of a rod member 2 according to the invention. In the case of this embodiment, too, the rod member 2 has a first rod element 4 and a second rod element 6. In addition, an engagement member 32, which is used here to prevent the two rod elements 4, 6 from rotating, is provided in this case. The reference number 35 again relates in this case to a spring element which pre-stresses this engagement member 32 at least radially outwards as well.

In the illustration shown in FIG. 3b an opening or bore 37 is provided which extends at a right angle to the plane of the figure in FIG. 2b. This bore 37 is used for receiving a retention means 34 in the form of a shaft shown in FIG. 2d.

FIG. 3c is a section through the illustration shown in FIG. 3a along the line A-A in FIG. 3a. It is evident in this case that the engagement member 32 is pivotable about an axis X, and an engagement means 39 is thus also pivotable radially, i.e. in the direction R towards the outside. In this case this engagement means 39 engages in a recess 38 shown in FIG. 2d in the region of the second rod element 6, i.e. expressed in more precise terms, of the first region 6a of the second rod element 6.

The reference number 14 again designates in this case the connecting portion which engages in the corresponding recess 12 in the second rod element 6. The connecting mechanism is formed in this case by the receiving area 12 and the connecting portion 14 on the one hand and by the engagement member 32 and the recess 38 on the other hand.

FIG. 3d is a further view of the rod member 2 shown in the preceding FIGS. 3a to 3c. In this case a non-circular engagement member 15, which is formed on the connecting portion 14 and which projects in the radial direction of the connecting portion, is clearly evident. This engagement member has three lugs which project in the radial direction. In order to join the first rod element 4 to the second rod element 6, this engagement member 15 can be inserted into a suitably adapted recess 42 which is formed on the second rod element 6. After this insertion the second rod element 6 can be rotated with respect to the first rod element 4, so that a movement of the second rod element 6 with respect to the first rod element 4 in the longitudinal direction L is prevented by the co-operation of the recess 42 and the engagement member 15.

The reference number 17 relates to an engagement portion into which the projections 42a of the recess 42 projecting radially inwards engage in the assembled state of the rod member.

At the same time, in the event of rotation the engagement member 32, in more precise terms the engagement portion 39, engages in a suitably shaped recess 38 on the second rod element 6, so that in this state too no rotation of the two rod elements 6 and 4 with respect to each other is possible.

In order to detach the two rod elements 4, 6 from each other, the user can press the engagement member 32 and thus pivot it inwards about the shaft 34. The shaft 34 projects through a bore 33 of the engagement member 32. In this way, the engagement projection 34 moves out of engagement with the recess 38 and rotation of the second rod element 6 with respect to the first rod element 4 becomes possible. As soon as the engagement member 15 and the recess 42 have been moved into alignment with each other, withdrawal of the second rod element 6 from the first rod element 4 is also possible.

It is pointed out that it would also be possible for the connecting elements in question to be designed in a reverse manner, for example for the engagement member to be provided on the second rod element 6. The design shown in FIG. 2d is preferable, however, since then a unitary connecting mechanism is arranged in each case on the rod element 4 and in this way the number of the closure parts can be reduced as a whole.

FIG. 4 shows a further embodiment of a rod member 2 according to the invention. Unlike the case of the previous embodiments, here the receiving area 12 is arranged on the first rod element and the engagement portion 14 is arranged on the second rod element. In this case the connecting mechanism is additionally formed by a magnet 46 which is arranged in the receiving area 12. This magnet 46 attracts a magnetizable area 47 of the connecting portion. It would also be possible, however, for the magnet to be arranged on the engagement portion 14. In addition, the magnet 46 and the magnetizable area 47 could touch each other. It would also be possible for two magnets to be provided, which are opposed to each other with opposite poles.

In this case the second rod element 6 has a recess 16 by way of which the second rod element can be gripped and withdrawn from the first rod element 4. It would also be possible, however, for this recess 16 to be dispensed with.

FIG. 5 shows a further embodiment of a rod member according to the invention. This embodiment is similar to the embodiment shown in FIG. 4, but in the case of the embodiment shown in FIG. 5 the connecting mechanism is formed not by a magnet, but by a screw fastening 49. In the case of this embodiment the user can likewise manually grip the recess 16 and unscrew the second rod element 6 from the first rod element 4. In addition, this recess could also be used for the application of a tool, such as for example an open-ended spanner, in order to loosen the connection between the rod elements 4, 6.

In addition, the rod members 2 shown in FIGS. 4 and 5 could also have rinsing bores (not shown) which extend in the longitudinal direction L of the rod member 2. In this case it would be possible for the magnet 46 also to be provided with a bore, but a plurality of magnets could also be provided which surround a corresponding rinsing bore.

All the features disclosed in the application documents are claimed as being essential to the invention, insofar as they are novel either individually or in combination as compared with the prior art.

1-15. (canceled)

16. An apparatus for shaping plastics material pre-forms to form plastics material containers, the apparatus comprising:
a blowing nozzle for filling a plastics material pre-form with a medium; and
a rod member which is arranged on a holding means and which is movable in a longitudinal direction of the plastics material pre-form in order to extend the plastics material pre form in the longitudinal direction thereof during a shaping procedure,
wherein the rod member is designed in a multiplicity of parts and has at least one first rod element arranged on the holding means, with which a second rod element is capable of being connected by means of a connecting mechanism capable of being released without any tools, and
wherein the second rod element has a contact face in order to contact an area of the plastics material pre-form, and
wherein the rod member is arranged on the holding means such that the second rod element for shaping plastics material pre-forms to form plastics material containers is capable of being inserted into an opening of the plastics material pre-form in order to extend the latter in the longitudinal direction thereof.

17. An apparatus according to claim 16, wherein the second rod element has a receiving area into which a connecting portion of the first rod element is capable of being inserted.

18. An apparatus according to claim 17, wherein the receiving area completely surrounds the connecting portion in the peripheral direction.

19. An apparatus according to claim 16, wherein the second rod element is capable of being withdrawn from the first rod element.

20. An apparatus according to claim 16, further comprising an engagement member capable of being moved radially with respect to the first rod element being arranged on the first rod element.

21. An apparatus according to claim 20, wherein the engagement member has an engagement portion which engages in an area of the second rod element in an assembled state of the rod elements.

22. An apparatus according to claim 20, wherein the first rod element has a recess in which at least one portion of the engagement member is arranged.

23. An apparatus according to claim 20, further comprising a spring element which pre-stresses the engagement member with respect to the first rod element.

24. An apparatus according to claim 20, wherein the first rod element has a retention means which prevents the engagement member from falling out of the first rod element.

25. An apparatus according to claim 20, wherein the engagement member is a spherical body.

26. An apparatus according to claim 20, wherein a plurality of engagement members are distributed uniformly around the external periphery of the first rod element.

27. An apparatus according to claim 20, wherein the engagement member is arranged so as to be pivotable about a pre-set pivot axis.

28. An apparatus according to claim 16, wherein an engagement member, the external cross-section of which is adapted to an internal cross-section of an engagement recess provided on the second rod element, is arranged on the first rod element.

29. An apparatus according to claim 16, wherein the first rod element and the second rod element are connected to each other by way of a connecting mechanism acting magnetically.

30. A rod member for an apparatus for shaping plastics material pre-forms to form plastics material containers, the rod member capable of being arranged on a holding means and being movable in a longitudinal direction of the plastics material pre-form in order to extend the plastics material pre-form in the longitudinal direction thereof during a shaping procedure, the rod member is designed in a multiplicity of parts comprising:
at least one first rod element capable of being arranged to the holding means; and
a second rod element capable of being connected to the first rod element by means of a connecting mechanism capable of being released without any tools,
wherein the second rod element has a contact face in order to contact an area of the plastics material pre-form, and
wherein the rod member is capable of being arranged on the holding means such that the second rod element for shaping plastics material pre-forms to form plastics material containers is capable of being inserted into an opening of the plastics material pre-form in order to extend the latter in the longitudinal direction thereof.

31. An apparatus for shaping plastics material pre-forms to form plastics material containers, the apparatus comprising:
a blowing nozzle configured to fill a plastics material pre-form with a medium; and
a rod member arranged on a holding mechanism, the rod member being movable in a longitudinal direction of the plastics material pre-form in order to extend the plastics material pre form in the longitudinal direction thereof during a shaping procedure,
wherein the rod member comprises
at least one first rod element arranged on the holding mechanism, and
a second rod element coupleable with said first rod element via a connecting mechanism, the connecting mechanism being releasable without any tools, the second rod element having a contact face structured and arranged to contact an area of the plastics material pre-form, and the rod member being arranged on the holding mechanism such that the second rod element for shaping plastics material pre-forms to form plastics material containers is insertable into an opening of the plastics material pre-form in order to extend the pre-form in the longitudinal direction thereof.

32. An apparatus according to claim 31, wherein the second rod element has a receiving area, a connecting portion of the first rod element being removably insertable into said receiving area.

33. An apparatus according to claim 31, further comprising an engagement member arranged on the first rod element, the engagement member being radially movable with respect to the first rod element.

34. An apparatus according to claim 33, further comprising a spring element which pre-stresses the engagement member with respect to the first rod element.

35. An apparatus according to claim 33, wherein the first rod element has a retention mechanism which prevents the engagement member from falling out of the first rod element.
